(19) United States
(12) Patent Application Publication
(10) Pub. No.: US 2025/0342426 A1
(43) Pub. Date: Nov. 6, 2025

(54) SYSTEMS AND METHODS FOR RISK MANAGEMENT NETWORKS

(71) Applicant: SmartContract Chainlink Limited SEZC, Grand Cayman (KY)

(72) Inventors: Lorenz Breidenbach, Zug (CH); Kostis Karantias, Grand Cayman (KY); Xueyuan Zhao, Grand Cayman (KY)

(73) Assignee: SmartContract Chainlink Limited SEZC, Grand Cayman (KY)

(21) Appl. No.: 19/267,526

(22) Filed: Jul. 12, 2025

Related U.S. Application Data
(60) Provisional application No. 63/370,376, filed on Aug. 4, 2022.
(60) Provisional application No. 63/672,192, filed on Jul. 16, 2024.
(60) Provisional application No. 63/842,290, filed on Jul. 11, 2025.
(60) Provisional application No. 63/842,314, filed on Jul. 11, 2025.

(51) Int. Cl. G06Q 10/0635; H04L 9/00

(52) U.S. Cl. CPC G06Q 10/0635; H04L 9/50; G06Q 2220/00

(57) ABSTRACT

Systems, devices, and methods provide for risk management between a source blockchain and a destination blockchain. A risk management network monitors transactions taking place utilizing a cross-chain interoperability protocol. The risk management network is separate from the transaction network. If aspects of the transaction (for example, committed and reconstructed Merkle roots) look as expected, the risk management network blesses the transaction and it proceeds to completion. In contrast, if an anomaly is detected, the risk management network curses the system and the transaction is paused so that the anomaly can be investigated and the transaction potentially reversed, cancelled, or otherwise modified.

### CROSS-REFERENCE TO RELATED APPLICATIONS

This application claims priority to and the benefit of: (i) U.S. Provisional Patent Application No. 63/670,376 filed Jul. 12, 2024 and entitled “CROSS-CHAIN INTEROPERABILITY PROTOCOL,” (ii) U.S. Provisional Patent Application No. 63/672,192 filed Jul. 16, 2024 and entitled “SYSTEMS AND METHODS FOR RISK MANAGEMENT NETWORKS,” (iii) U.S. Provisional Patent Application No. 63/842,290 filed Jul. 11, 2025 and entitled “CROSS-CHAIN INTEROPERABILITY PROTOCOL,” and (iv) U.S. Provisional Patent Application No. 63/842,314 filed Jul. 11, 2025 and entitled “SYSTEMS AND METHODS FOR RISK MANAGEMENT NETWORKS.” The foregoing applications are hereby incorporated by reference in their entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### FIELD

This disclosure is in the field of distributed systems, and in particular the field of risk management related to transferring data using blockchain and distributed network computing.

### BACKGROUND

Prior approaches for processing data using a blockchain system have suffered from various limitations, for example limitations related to security and validation of transactions on blockchains or between multiple blockchains. As the number of blockchains grows, people and applications are looking for ways to best make use of new chains and their features. There is a need for programs which validate and ensure secure transactions across blockchains and interoperability among systems. Accordingly, systems and methods offering improvements thereto remain highly desirable.

### SUMMARY

In an exemplary embodiment, a risk management network comprises one or more processors configured by machine-readable instructions to: monitor, by a risk management node, a destination blockchain for a committed message; identify, by the risk management node, a Merkle root associated with the committed message; receive, by the risk management node, one or more source messages from a source blockchain; determine, by the risk management node, a reconstructed Merkle root based on the one or more messages of the source blockchain; and compare, by the risk management node, the reconstructed Merkle root to the Merkle root associated with the committed message.

In another exemplary embodiment, a method of risk management in a cross-blockchain network environment comprises monitoring, by a risk management node, a destination blockchain for a committed Merkle root; receiving, by the risk management node, one or more source messages from a source blockchain; determining, by the risk management node, a reconstructed Merkle root based on the one or more messages of the source blockchain; and comparing, by the risk management node, the reconstructed Merkle root to the committed Merkle root.

In another exemplary embodiment, a risk management network system comprises: a processor; and a tangible, non-transitory memory configured to communicate with the processor, the tangible, non-transitory memory having instructions stored thereon that, in response to execution by the processor, cause the processor to perform operations comprising: monitoring, by a risk management node, a destination blockchain for a committed Merkle root; receiving, by the risk management node, one or more source messages from a source blockchain; determining, by the risk management node, a reconstructed Merkle root based on the one or more messages of the source blockchain; and comparing, by the risk management node, the reconstructed Merkle root to the committed Merkle root.

### BRIEF DESCRIPTION OF THE DRAWINGS

The accompanying drawings are included to provide a further understanding of the present disclosure and are incorporated in, and constitute a part of, this specification, illustrate various exemplary embodiments, and together with the description, serve to explain exemplary principles of the disclosure.

FIG. 1 illustrates a cross-chain interoperability protocol system comprising a risk management network, in accordance with various exemplary embodiments;

FIG. 2 illustrates a blockchain system comprising a risk management network, in accordance with various exemplary embodiments;

FIG. 3 illustrates a method of risk management in a cross-blockchain network environment, in accordance with various exemplary embodiments; and

FIG. 4 illustrates a blockchain system comprising a risk management network and a home chain, in accordance with various exemplary embodiments.

### DETAILED DESCRIPTION

The detailed description of various exemplary embodiments herein makes reference to the accompanying drawings, which show various exemplary embodiments by way of illustration. While these various exemplary embodiments are described in sufficient detail to enable those skilled in the art to practice the disclosure, it should be understood that other embodiments may be realized and that structural, logical, and/or similar changes may be made without departing from the spirit and scope of the disclosure. Thus, the detailed description herein is presented for purposes of illustration and not of limitation.

For example, steps recited in any of the method or process descriptions may be executed in any suitable order, and are not necessarily limited to the order presented. Furthermore, any reference to singular may include plural embodiments, and any reference to more than one component or step may include a singular embodiment or step.

Systems, devices, and methods for risk management networks are shown, such as risk management network. Various exemplary embodiments of risk management networks are disclosed herein. A risk management network may be a component of a cross-chain transaction system, such as a cross-chain interoperability system. A risk management network may be a system for active risk management and anti-fraud. Moreover, a risk management network may be a hybrid system comprising offchain and onchain components.

Use of a risk management network offers significant advantages over prior approaches. For example, an exemplary risk management network may utilize a group of nodes that are entirely separate from a group of transactional DON nodes. Additionally, an exemplary risk management network may utilize a code base that is entirely distinct from any other code base, reducing the likelihood of any particular exploit simultaneously affecting the risk management network code base and the transactional DON code base. Yet further, the code base of an exemplary risk management network may be small, for example around 10,000 lines of code, with such compact size allowing for a higher degree of trusted computing, code verification, and so forth.

Moreover, use of a risk management network can significantly reduce fraudulent transactions and/or losses associated with cross-chain interaction. By way of example, as of late 2023 more than $2B in value has been lost to cross-chain bridge exploits. In contrast, use of a risk management network can reduce and/or eliminate cross-chain bridge exploits and attendant losses

Various exemplary embodiments herein discuss Merkle trees and Merkle roots. More generally, principles of the present disclosure contemplate use of any suitable cryptographic commitment approaches or techniques, and the exemplary embodiments utilizing Merkle principles are provided by way of illustration and not of limitation.

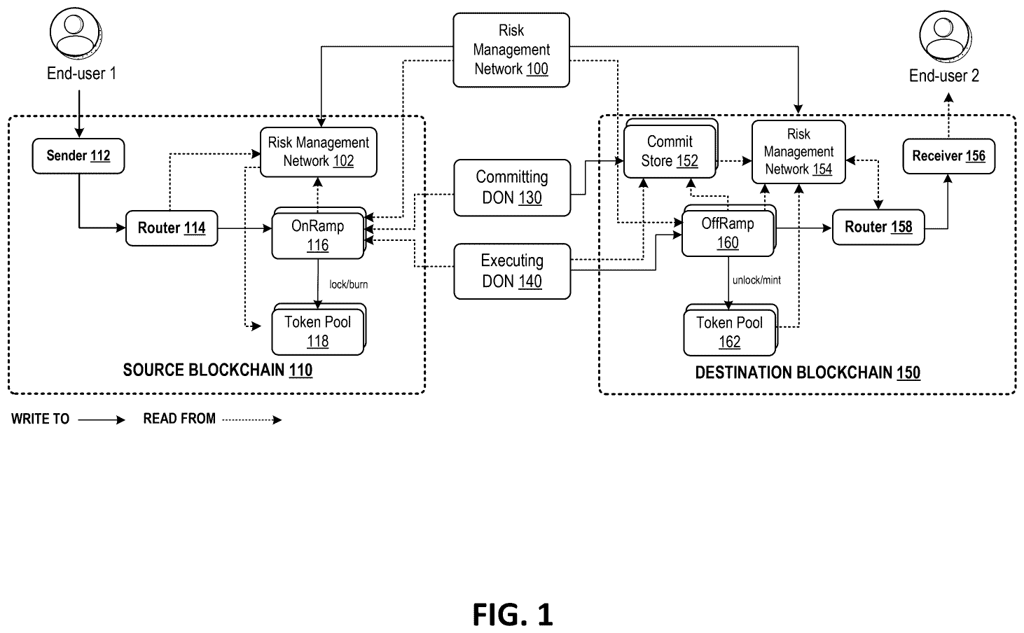

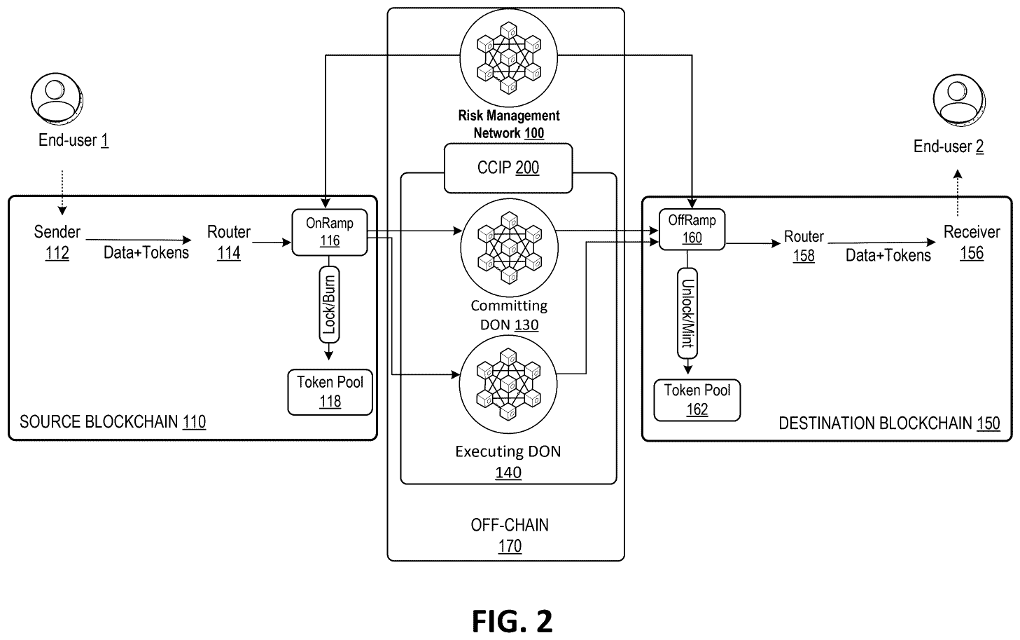

With reference to FIGS. 1 and 2, a risk management network 100 is shown in accordance with various exemplary embodiments. The risk management network 100 for the purposes of this disclosure may comprise the separate network 100 as well as various components on a source blockchain 110, a destination blockchain 150, committing DON 130 and/or executing DON 140. In various exemplary embodiments, the risk management network 100 may be an independent network that monitors and validates the cross-chain interoperability system 200.

In various exemplary embodiments, the risk management network 100 may comprise one or more risk management contracts. For example, in various exemplary embodiments, there may be one risk management contract per supported chain. In various exemplary embodiments, a supported chain may be used to refer to a blockchain or other chain for recording data which is supported by the cross-chain interoperability system 200. The risk management contracts may be onchain components in the system. The risk management network may comprise one or more risk management nodes. The risk management nodes may be offchain components of the system. The risk management network may comprise n risk management nodes configured to continually monitor the one or more supported chains. The risk management nodes may be configured to monitor the supported chains for abnormal activity.

In various exemplary embodiments, the risk management network 100 may act as a secondary validation service parallel to the cross-chain interoperability system 200. For example, wherein the cross-chain interoperability system 200 may transfer messages across one or more chains, the risk management network 100 may monitor the system. The risk management network 100 may comprise a lightweight form of n-version programming (NVP) that continually monitors the behavior of the primary cross-chain interoperability system 200. The risk management network 100 may be independent from the primary cross-chain interoperability system 200. This provides the benefit of increased security by reducing the likelihood that the risk management network 100 and the primary system, the cross-chain interoperability system 200, are affected by the same (hypothetical) security vulnerability. The risk management network 100 also provides the benefit of minimizing external dependencies to reduce the risk of supply chain attacks.

In various exemplary embodiments, the risk management network 100 may interact with one or more source blockchains 110 and destination blockchains 150. The risk management network 100 may interact with the source blockchains 110 and destination blockchains 150 supported by the cross-chain interoperability system 200. Moreover, the risk management network 100 may not interact with the cross-chain interoperability system 200 itself directly outside its interaction with the source blockchains 110 and destination blockchains 150. The risk management network 100 may not interact with the primary system in any other way. Additionally, the individual risk management nodes may, in various exemplary embodiments, only interact with one another via the source blockchain 110 and/or destination blockchain 150.

In various exemplary embodiments, the risk management network 100 may comprise two main modes of operations. The risk management network 100 may comprise blessing and cursing operations/functions/modes. The blessing and cursing may both run in parallel.

Various exemplary embodiments are discussed herein in connection with use of Merkle roots. It will be appreciated that other embodiments may utilize other cryptographic commitments. Moreover, various exemplary embodiments are discussed herein in connection with reconstruction of Merkle roots. It will be appreciated that other exemplary embodiments may not reconstruct them, but may instead furnish proofs of inclusion, for example.

In various exemplary embodiments, the blessing may comprise monitoring and blessing of messages (roots of messages, sequences of messages, and so forth). For example, the risk management nodes may continually monitor information or messages that are committed to the destination blockchain 150. In various exemplary embodiments, the risk management nodes may monitor Merkle roots of messages that are committed on each destination blockchain 150. In various exemplary embodiments, when a new Merkle root appears based on the destination blockchain 150, the risk management nodes may be configured to verify the accuracy of the Merkle root. For example, the risk management node may attempt to independently reconstruct the Merkle root by fetching all messages contained in the Merkle tree from the finalized prefix of the source blockchain 110. The risk management node may then check that the independently constructed reconstructed Merkle root matches Merkle root. Due to the collision-resistance property of Merkle trees, if the Merkle tree contains any message that does not exactly match what the risk management node observes on the source blockchain 110, the Merkle root observed on the destination blockchain 150 will not match the reconstructed Merkle root. If the Merkle root observed on the destination blockchain 150 matches the reconstructed Merkle root, then the risk management node will bless the Merkle root. Upon successfully verifying a match, the risk management node will send a vote to bless the Merkle root to the risk management contract. The risk management contract may receive the vote from the risk management node. The risk management contract may keep track of the votes received from one or more risk management nodes. The risk management contract may determine if a quorum of votes has been reached, and will consider a Merkle root blessed.

In various exemplary embodiments, the cross-chain interoperability system 200 may comprise an OffRamp contract 160. The OffRamp contract 160 may ensure that only messages in a Merkle root that is blessed by the risk management contract may be executed. This ensures that the system is protected from security vulnerabilities in the offchain system of the cross-chain interoperability system 200 that may lead to mistakenly committed Merkle roots. The risk management network 100 will ensure that inaccurate or fraudulent Merkle roots are not blessed and reduce or diminish the likelihood of error. Additionally, the risk management network 100 owner may undo a mistaken blessing. The ability to undo a mistaken blessing provides the benefit of an escape hatch in case of bugs in the offchain blessing logic leading to false blessings.

In various exemplary embodiments, the cursing may comprise identifying an abnormality with the Merkle root verification and marking the system as cursed. The risk management node may detect an abnormality in the Merkle root and consequently, it may mark the curse on the cross-chain interoperability system 200. The risk management node may continually monitor the one or more blockchains for anomalies. If an anomaly is detected by a risk management node, the risk management node may send votes to curse on one or more corresponding risk management contracts. The risk management node may send votes to curse to all RMN contracts on all chains. Once a quorum of such votes has been reached on a chain, the risk management contract may mark a curse and the cross-chain interoperability system 200 may be paused on that chain. The cross-chain interoperability system 200 may be paused until the situation is assessed by the owner, and the curse is potentially lifted. For example, cross-chain interoperability protocol contracts may be directly connected to a risk management contract, and thus the CCIP contracts may automatically be considered paused when the risk management contract is cursed.

In various exemplary embodiments, abnormalities that may be identified by the risk management network 100 include, but are not limited to, finality violations and execution safety violations. Finality violations may include where finality is violated on one of the source blockchains 110. A finality violation may include where the source blockchain 110 violates the safety parameters set by the risk management network 100. An execution safety violation may occur when a message is executed for which there is no matching message on the source blockchain 110. In various exemplary embodiments, double executions of messages may result in an execution safety violation. It can be appreciated that each message from a source blockchain 110 may only be executed once on a destination blockchain 150. In various exemplary embodiments, the risk management network 100 may also identify additional abnormalities, wherein the nodes recognize inconsistencies between the information on the source blockchain 110 and the destination blockchain 150. For example, abnormalities may include violations of token amount conservation or token transfers for which there is no explanation, in later versions. The risk management nodes may adopt one or more strategies to increase the likelihood that the identified abnormalities are indeed a result of incorrect functioning of the primary system (and/or a result of malicious behavior), rather than a result of a localized issue, in order to reduce the incidence of false positive votes to curse. In various exemplary embodiments, the RMN owner may also directly trigger a curse.

In various exemplary embodiments, the risk management contract may expose a two-method interface to the other CCIP contracts that corresponds to the two modes of operation, i.e. blessed and cursed. For example, the function isBlessed(root) returns a boolean indicating whether the root is blessed, and the function isCursed() returns a boolean indicating whether the risk management network 100 has cursed. The risk management network 100 may maintain a group of risk management nodes, which may be authenticated by their addresses and may be authorized to participate in the risk management network 100. Each of the one or more risk management nodes may be configured with a plurality of addresses, for example: an address from which the node votes to bless, an address from which the node votes to curse, and an address from which the note unvotes to curse. Moreover, each of the one or more risk management nodes may be configured with a blessing weight and a curse weight.

In various exemplary embodiments, the risk management contract may maintain one or more thresholds that are used to determine whether a quorum has been reached on blessing and/or cursing. For example, the risk management contract may determine the blessing threshold and/or the cursing threshold. In various exemplary embodiments, blessing threshold may be determined based on comparing the votes of the roots to the blessed threshold. For example, blessing threshold may weigh the sum of the weights for all nodes who have voted for a root, and when the sum exceeds or is equal to the blessing threshold, the root is considered a blessed root. The cursing threshold may be configured to determine a cursed root. Every vote to curse carries a cursed identifier. For example, a cursed identifier may be a random 32 byte id assigned by the risk management node that sends the vote. A risk management node may have multiple active votes to curse at any time. A risk management node may be considered to have voted to curse if there is at least one active vote to curse by that risk management node. If the sum of the weights of the risk management nodes that have voted to curse exceeds the curse threshold, the risk management contract considers the system cursed. In various exemplary embodiments, a risk management node may have voted (accurately, and/or erroneously) to curse a system once or multiple times, and while the risk management contract has not cursed, the risk management node has the ability to undo all their votes to curse (but not to lift the curse).

In various exemplary embodiments, wherein the risk management contract has cursed a system, only the owner of the risk management contract may interact with it. The owner may unvote to curse on behalf of the risk management nodes. If, as a result of this, enough active votes to curse are inactivated such that the sum of weights of risk management nodes with active votes to curse drops below the curse threshold, the curse is lifted.

In various exemplary embodiments, the risk management network 100 may monitor the chain using event logs. For example, the offchain implementation of the risk management network 100 may use event logs to determine the events onchain. The risk management network 100 may query the chain to determine the activity on the chain. For example, the risk management network 100 may query the chain using an eth call to request information.

In various exemplary embodiments, the risk management network 100 may operate with chain comprising unstable suffixes and may re-org, wherein the re-orgs don't violate finality are handled by the risk management network 100. In various exemplary embodiments, re-orgs that violate finality may result in a curse.

In various exemplary embodiments, chain interactions of the risk management network 100 may be performed via JSON-RPC, or other suitable protocol on a configurable set of blockchain nodes.

In various exemplary embodiments, the risk management contract may be managed by an owner, as discussed herein. The owner may be the owner of the risk management network 100 and the corresponding cross-chain interoperability system 200.

In various exemplary embodiments, the source blockchain 110 may comprise a router 114 and the destination blockchain 150 may comprise a router 158. The routers 114, 158 may comprise a router contract, also referred to as a smart contract. The router contract may be configured to facilitate and route communication between the source blockchain 110 and destination blockchain 150. The router 114 may be configured to receive a cross-chain message from a sender 122, validate a cross chain message and direct a cross-chain message to a destination chain 150. The router 158 may be configured to receive a cross-chain message and assist with executing a cross-chain message on a destination chain 150.

In various exemplary embodiments, the risk management network 100 may comprise one or more risk management nodes as discussed herein. In various exemplary embodiments, the risk management nodes may include risk management network 102 and/or risk management network 154. In various exemplary embodiments, the risk management network 100 may comprise n risk management nodes.

In various exemplary embodiments, risk management network 100 may comprise offchain and onchain components, as discussed herein. The risk management network 100 may comprise a risk management network contract, also referred to as an RMN contract. The risk management network 100 may comprise one RMN contract per supported blockchain. For example, each supported blockchain may have an RMN contract on the risk management network 100. In various exemplary embodiments, the risk management network 100 may comprise one or more nodes, also referred to as RMN nodes, risk management nodes, and/or RMN offchain nodes. In various exemplary embodiments, the risk management network 100 may comprise n RMN nodes configured to monitor the supported blockchains. In various exemplary embodiments, some of the RMN nodes may be configured to vote for a decision to be accepted by the contract and thereby recorded on the blockchain.

In various exemplary embodiments, the RMN 100 may be configured to monitor the CCIP 200 and acts as a secondary validation service. In various exemplary embodiments, the RMN 100 is separate from the CCIP 200, meaning it operates independently and checks the accuracy of the CCIP 200. In various exemplary embodiments, the RMN 100 may be configured to interact with the source chain 110 and the destination chain 150 and not directly with the CCIP 200. Additionally, in various exemplary embodiments, each RMN node may only interact with one another via the blockchains.

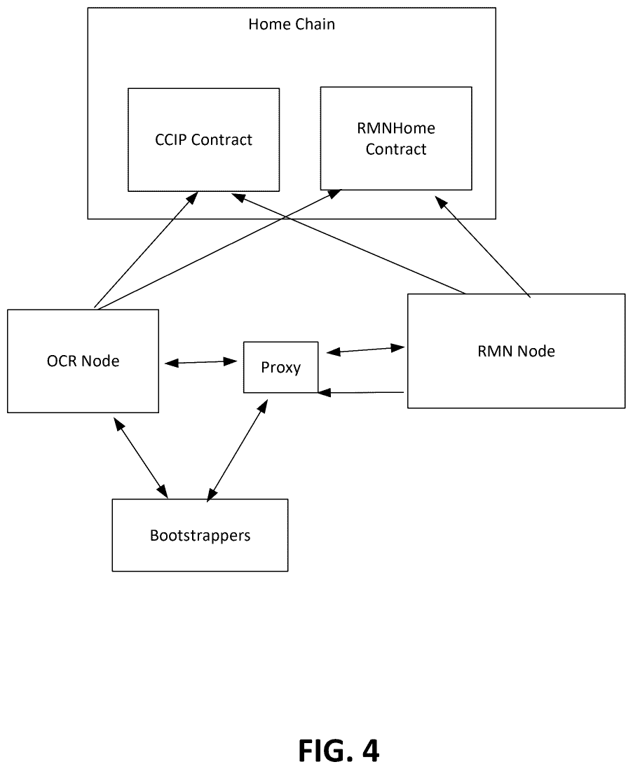

With reference to FIG. 4, a RMN 100 comprising a home chain is shown in accordance with various exemplary embodiments. In various exemplary embodiments, the RMN 100 may comprise RMN reports. For example, the RMN reports may comprise a commit reporting plugin configured to fetch RMN observations (for example signatures or blessings) for every lane of interest, and once enough matching observations are accumulated, for all lanes of interest, they will be sent back to a subgroup of RMN nodes to produce a final RMN report containing those lane updates. In various exemplary embodiments, the RMN contract may be configured to verify at most fSigners+1 signatures, instead of fObservers+1 signatures per lane update.

In various exemplary embodiments, the RMN 100 may comprise a home chain, wherein the home chain comprises a home chain contract for configuring the communication from a source chain 110 to a destination chain 150. In various exemplary embodiments, a home chain contract may comprise configuration data readable by nodes, such as RMN nodes.

In various exemplary embodiments, the RMN contracts may comprise RMNHome and RMNRemote. RMNHome may contain information for verifying RMN observations and producing RMN reports. The RMNHome may be on the home blockchain. RMNRemote may contain information required for verifying RMN reports, and may be stored on one or more of the destination chains 150 as well as the home chain. In various exemplary embodiments, the OffRamp contract may interact only with the RMNRemote contract of the RMN 100.

In various exemplary embodiments, the RMN node may communicate with the OCR node, for example by a proxy between the OCR instance and the RMN node. In various exemplary embodiments, messages may be sent between the OCR nodes and RMN nodes.

In various exemplary embodiments, the RMN 100 may comprise a RMN home contract which may be deployed on the home chain. The RMN home contract may comprise configuration data. In various exemplary embodiments, the CCIP 200 may refer to the RMN home contract, for example to determine identification information of the RMN nodes to interact with and what blockchains the RMN node supports. In various exemplary embodiments, the RMN 100 may comprise multiple active configurations at the same time to increase speed and reduce down time.

In various exemplary embodiments, the RMN remote contract, or RMNRemote, may be deployed on one or more chains including the home chain, source chain 110 and/or destination chain 150.

In various exemplary embodiments, the RMN 100 may communicate with the CCIP 200 off chain 170 to produce one or more reports. For example, the RMN nodes of the RMN 100 may communicate with the CCIP nodes of the CCIP 200. The RMN 100 may sign observations with an off chain private key corresponding to the off chain public key.

In various exemplary embodiments, the CCIP 200 may comprise a reporting plugin for communicating with the RMN nodes of the RMN 100. In various exemplary embodiments, the communication between the CCIP reporting plugin and RMN nodes may comprise the steps of sending by the reporting plugin an observation request to the RMN node and receiving by the reporting plugin a signed observation in response. The reporting plug in may send a reporting signature request to the RMN node and receive a report signature in response to the request. In various exemplary embodiments, the RMN 100 may verify the signature, and attribute to a configured RMN node.

In various exemplary embodiments, the RMN 100 comprise keys across one or more blockchains. In various exemplary embodiments, the RMN 100 cursing as described may be removed. In various exemplary embodiments, the CCIP 200 may perform the functions similar to the cursing described herein. The CCIP 200 may perform finality violation detection. The CCIP 200 may detect abnormalities.

In various exemplary embodiments, the node operators (NOPs) may operate one or more nodes of the system. The NOP may recover funds from their deprecated per-chain vote to bless and vote to curse addresses. The RMN node may accept network messages from the oracles in the CCIP commit instances, through a proxy. The connection between an oracle and an RMN node may be encrypted and authenticated. For safety, every meaningful method of the RMN server may return a signed response, with the Ethereum bless key of the RMN node.

In various exemplary embodiments, a RMN Node may comprise a keystore including a private key used by the RMN node to interact with supported chains. The keystore may contain one or more private keys, including a key for voting to bless and/or a key for voting to curse, for each supported chain.

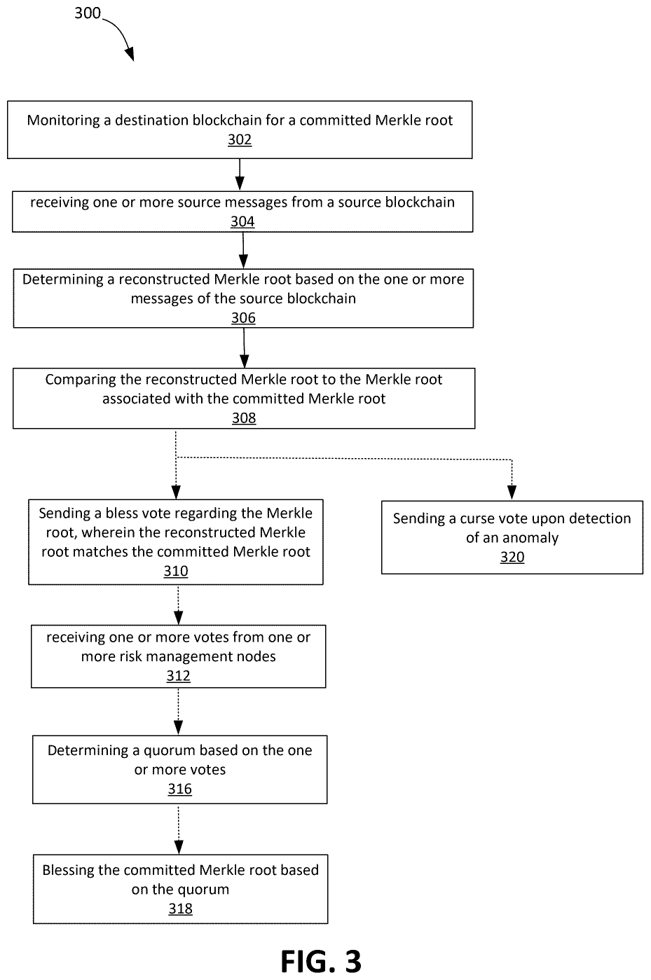

With reference now to FIG. 3, a method for risk management in a cross-blockchain network environment 300 may be implemented, for example via risk management network 100. The method 300 includes monitoring, by a risk management node, a destination blockchain for a committed Merkle root (step 302). In various exemplary embodiments, the method 300 includes receiving, by the risk management node, one or more source messages from a source blockchain (step 304). Method 300 may include determining, by the risk management node, a reconstructed Merkle root based on the one or more messages of the source blockchain (step 306). Method 300 may include comparing, by the risk management node, the reconstructed Merkle root to the Merkle root associated with the committed Merkle root (step 308).

Method 300 may optionally include sending, by the risk management node, a bless vote regarding the Merkle root, wherein the reconstructed Merkle root matches the committed Merkle root (step 310). Method 300 may optionally include receiving, by a risk management contract, one or more votes from one or more risk management nodes, wherein the one or more votes are based on the comparing the reconstructed Merkle root to the committed Merkle root (step 310). Method 300 may optionally include determining, by the risk management contract, a quorum based on the one or more votes (step 312). Method 300 may optionally include blessing, by the risk management contract, the committed Merkle root based on the quorum (step 314). Method 300 may optionally include sending, by the risk management node, a curse vote upon detection of an anomaly (step 316).

In addition to all the foregoing, principles of the present disclosure may be compatible with, complimentary to, and/or utilized in connection with principles set forth in:

U.S. Ser. No. 16/553,292 filed Aug. 28, 2019, now U.S. Pat. No. 11,854,101 entitled “Systems, Methods, and Storage Media for Interfacing At Least One Smart Contract Stored on A Decentralized Architecture With External Data Sources;”

U.S. Ser. No. 17/471,035 filed on Sep. 9, 2021, entitled “Computer Network Transaction Sequencing Method and System;”

U.S. Ser. No. 17/678,769 filed on Feb. 23, 2022, now U.S. Pat. No. 12,074,853 entitled “Method and Apparatus for Providing Secure Information to a Decentralized Computing Environment;” and

U.S. Ser. No. 18/207,888 filed on Jun. 9, 2023, now U.S. Patent Application Publication No. 2023-0318857 entitled “Method and Apparatus for Producing Verifiable Randomness Within a Decentralized Computing Network.”

The contents of each of the foregoing applications and patents are incorporated herein by reference, but except for any subject matter disclaimers or disavowals, and except to the extent that the incorporated material is inconsistent with the express disclosure herein, in which case the language in this disclosure shall control.

For the sake of brevity, conventional database management, network communication, computer networking, data compression, error checking, and other aspects of exemplary systems and methods (and components thereof) may not be described in detail herein. Furthermore, the connecting lines shown in the various figures contained herein are intended to represent functional relationships and/or physical or communicative couplings between the various elements. It should be noted that many alternative or additional functional relationships or physical or communicative connections may be present in a practical risk management network or related methods.

While the description references specific technologies, system architectures and data management techniques, practitioners will appreciate that this description is of various exemplary embodiments, and that other devices and/or methods may be implemented without departing from the scope of principles of the present disclosure.

While the steps outlined herein represent exemplary embodiments of principles of the present disclosure, practitioners will appreciate that there are many suitable computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods, and computer program products are provided. In the detailed description herein, references to “various exemplary embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement principles of the disclosure in alternative embodiments.

For example, the steps recited in any of the method or process descriptions may be executed in any suitable order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F.3d 1338, 1342-43 (Fed. Cir. 2008)). For example, the description or claims may refer to a processor for convenience, but principles of the disclosure contemplate that the processor may be multiple processors. The multiple processors may handle separate tasks or combine to handle certain tasks. Although specific advantages have been enumerated herein, various exemplary embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A risk management network, comprising:
one or more processors configured by machine-readable instructions to:
monitor, by a risk management node, a destination blockchain for a committed message;
identify, by the risk management node, a Merkle root associated with the committed message;
receive, by the risk management node, one or more source messages from a source blockchain;
determine, by the risk management node, a reconstructed Merkle root based on the one or more messages of the source blockchain; and
compare, by the risk management node, the reconstructed Merkle root to the Merkle root associated with the committed message.

2. The risk management network device of claim 1, wherein the one or more processors are further configured by the machine-readable instructions to:
send, by the risk management node, a bless vote regarding the Merkle root, wherein the reconstructed Merkle root matches the Merkle root associated with the committed message.

3. The risk management network device of claim 2, wherein the one or more processors are further configured by the machine-readable instructions to:
receive, by a risk management contract, one or more votes from one or more risk management nodes, wherein the one or more votes are based on comparing the reconstructed Merkle root to the Merkle root observed on the destination blockchain for the committed message.

4. The risk management network device of claim 3, wherein the one or more processors are further configured by the machine-readable instructions to:
determine, by the risk management contract, a quorum based on the one or more votes.

5. The risk management network device of claim 4, wherein the one or more processors are further configured by the machine-readable instructions to:
bless, by the risk management contract, the Merkle root associated with the committed message based on the quorum.

6. The risk management network device of claim 5, wherein the determining the quorum is based on determining whether the sum of weights of all votes for the Merkle root exceeds a blessing threshold.

7. The risk management network device of claim 1, wherein the one or more processors are further configured by the machine-readable instructions to send, by the risk management node, a curse vote applicable to a detected anomaly.

8. A method of risk management in a cross-blockchain network environment, the method comprising:
monitoring, by a risk management node, a destination blockchain for a committed Merkle root;
receiving, by the risk management node, one or more source messages from a source blockchain;
determining, by the risk management node, a reconstructed Merkle root based on the one or more messages of the source blockchain; and
comparing, by the risk management node, the reconstructed Merkle root to the committed Merkle root.

9. The method of claim 8, further comprising sending, by the risk management node, a bless vote if the reconstructed Merkle root matches the committed Merkle root.

10. The method of claim 9, further comprising receiving, by a risk management contract, one or more votes from one or more risk management nodes, wherein the one or more votes are based on the comparing the reconstructed Merkle root to the committed Merkle root.

11. The method of claim 10, further comprising determining, by the risk management contract, a quorum based on the one or more votes.

12. The method of claim 11, further comprising blessing, by the risk management contract, the committed Merkle root based on the quorum.

13. The method of claim 12, wherein each vote has an associated weight, and wherein the determining the quorum is based on determining whether the sum of the weight of each vote exceeds a threshold.

14. The method of claim 8, further comprising sending, by the risk management node, a curse vote upon detection of an anomaly.

15. The method of claim 14, further comprising pausing processing the one or more messages responsive to the curse vote.

16. A risk management network system, comprising:
a processor; and
a tangible, non-transitory memory configured to communicate with the processor, the tangible, non-transitory memory having instructions stored thereon that, in response to execution by the processor, cause the processor to perform operations comprising:
monitoring, by a risk management node, a destination blockchain for a committed Merkle root;
receiving, by the risk management node, one or more source messages from a source blockchain;
determining, by the risk management node, a reconstructed Merkle root based on the one or more messages of the source blockchain; and
comparing, by the risk management node, the reconstructed Merkle root to the committed Merkle root.

17. The risk management network system of claim 16, wherein the operations further comprise sending, by the risk management node, a bless vote if the reconstructed Merkle root matches the committed Merkle root.

18. The risk management network system of claim 17, wherein the operations further comprise receiving, by a risk management contract, one or more votes from one or more risk management nodes, wherein the one or more votes are based on the comparing the reconstructed Merkle root to the committed Merkle root.

19. The risk management network system of claim 18, further comprising determining, by the risk management contract, a quorum based on the one or more votes.

20. The risk management network system of claim 19, further comprising blessing, by the risk management contract, the committed Merkle root based on the quorum.

21. The risk management network system of claim 19, wherein each vote has an associated weight, and wherein the determining the quorum is based on determining whether the sum of the weight of each vote exceeds a threshold.
